(19) United States
(12) Patent Application Publication
(10) Pub. No.: US 2007/0052669 A1
(43) Pub. Date: Mar. 8, 2007

(54) Electrophoretic display panel

(75) Inventors: Guofu Zhou, Eindhoven (NL); Masaru Yasui, Kobe-City (JP); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/574,451

(22) PCT Filed: Oct. 5, 2004
(86) PCT No.: PCT/IB04/51977

§ 371 Date: Apr. 4, 2006

(30) Foreign Application Priority Data
Oct. 7, 2003 (EP) 03103702.1

(51) Int. Cl. G09G 3/34

(52) U.S. Cl. 345/107

(57) ABSTRACT

An electrophoretic display panel (1), comprises drive means (100) for controlling the potential difference of each picture element (2) to be a reset potential difference for enabling particles (6) to substantially occupy one of the extreme positions, and subsequently to be a grey scale potential difference for enabling the particles (6) to occupy the position corresponding to the image information. The drive means are arranged for applying, at least for reset potential differences representing 50% or more of the maximum reset pulse energy, one or more pulses (Rp, SDp) having a voltage value of substantially less than the reset value in between a reset potential difference and a grey scale potential difference,

The invention relates to an electrophoretic display panel, comprising:
an electrophoretic medium comprising charged particles;
a plurality of picture elements;
electrodes associated with each picture element for receiving a potential difference; and
drive means,
   the drive means being arranged for controlling the potential difference of each of the plurality of picture elements
to be a reset potential difference having a reset value and a reset duration during a reset period, and subsequently
to be a grey scale potential difference for enabling the particles to occupy the position corresponding to image information.

The invention also relates to a method for driving an electrophoretic display device in which method a grey scale potential difference is applied to a picture element of the display device after application of a reset potential difference.

An embodiment of the electrophoretic display panel of the type mentioned in the opening paragraph is described in International Patent Application WO 02/073304.

In the described electrophoretic display panel, each picture element has, during the display of the picture, an appearance determined by the position of the particles. The position of the particles depends, however, not only on the potential difference but also on the history of the potential difference. As a result of the application of the reset potential difference the dependency of the appearance of the picture element on the history is reduced, because particles substantially occupy one of the extreme positions before a grey scale potential difference is applied. Thus the picture elements are each time reset to one of the extreme states. Subsequently, as a consequence of the application of the grey scale potential difference, the particles occupy the position to display the grey scale corresponding to the image information. “Grey scale” is to be understood to mean any intermediate state. When the display is a black and white display, “grey scale” indeed relates to a shade of grey, when other types of colored elements are used ‘grey scale’ is to be understood to encompass any intermediate state in between extreme optical states.

When the image information is changed the picture elements are reset. After resetting the grey scales are set by application of a grey scale potential difference.

A disadvantage of the present display is that it may exhibit an effect which leads to inaccurate grey scale reproduction. Accurate grey scale reproduction is of prime importance. Although application of the reset pulses greatly increases the accuracy of grey scale reproduction the inventors have realized that despite the use of reset pulses nevertheless a less then optimal grey scale reproduction may occur.

It is an object of the invention to provide a display device of the type mentioned in the opening paragraph which can be applied to improve the reproduction of grey scales.

To this end the drive means are further arranged for applying, at least for reset potential differences representing 50% or more of the maximum reset energy, one or more pulses having a voltage value of substantially less than the reset value in a time period in between application of a reset potential difference and a grey scale potential difference of opposite sign.

Preferably the drive means are arranged for arranged for applying for all reset potential differences one or more pulses having a voltage value of substantially less than the reset value in a time period in between application of a reset potential difference and a grey scale potential difference of opposite sign.

Within the concept of the present invention a potential difference of substantially less than the reset value in a time period between a reset pulse (=reset potential difference) and a grey scale pulse (=grey scale potential difference) for at least the more energetic reset pulses.

Preferably the time period is at least one frame time.

The invention is based on the following insights:

Application of an reset pulse brings the particles to a extreme optical state (e.g white or black). This is advantageous since the state (position of) the electrophoretic particles is more or less fixed before application of a grey scale difference potential. Starting from a fixed position, grey scale can be more accurately applied. However, apart from the position of the particles the application of the reset pulse also influences the momentum of the particles, since the particles move under influence of the reset potential difference to the positions in accordance with the extreme optical state. The inventors have realized that an immediate application of a grey scale potential difference leads to some inaccuracy of the grey scale. During at least some time of the application of the grey scale difference, the particles are actually still loosing momentum. In a device in accordance with the invention a rest pulse is applied in between the reset pulse and the grey scale pulse. The application of the rest pulse brings the particles to a stop, due to the viscosity of the material. At the start of the application of the gray scale potential difference not just the position of the particles is fixed, but also their momentum (ideally the momentum is zero). By applying pulses of a voltage value substantially less than the reset value the movement of the particles is slowed down, preferably brought to a halt. Since the momentum of the particles is less, the effect of application of the grey scale potential difference is better defined, and therefore less variation in the actual grey scale occurs. Such a pulse could be called a “slow down” pulse.

In embodiments of the invention the device comprises means for applying in between the reset pulse and the grey scale potential difference one or more pulses with steadily reducing voltage value.

In embodiments of the invention the device comprises means for applying in between the reset pulse and the grey scale potential difference a rest pulse of zero voltage value.

Within the concept of the present invention a rest pulse means the application of a potential difference of substantially 0 Volt in a time period between a reset pulse (=reset potential difference) and a grey scale pulse (=grey scale potential difference).

The time period between the reset pulse and the grey scale potential difference is sufficient to reduce the average momentum of the particles substantially, the required time depends on for instance the viscosity of the material and the applied reset value.

Preferably the time period is at least 2 msec.

In preferred embodiments the time period is at least one frame time.

In preferred embodiments the device comprises means for establishing the time period in dependence on the energy applied during the application of the reset pulse. The energy applied by the reset pulse is proportional to the product of the time and value of the reset pulse. The momentum of the particles is a.o. dependent on the energy applied during the reset pulse. The higher the energy, the higher the momentum, the longer the rest or slow-down pulse.

These and other aspects of the display panel of the invention will be further elucidated and described with reference to the drawings, in which:

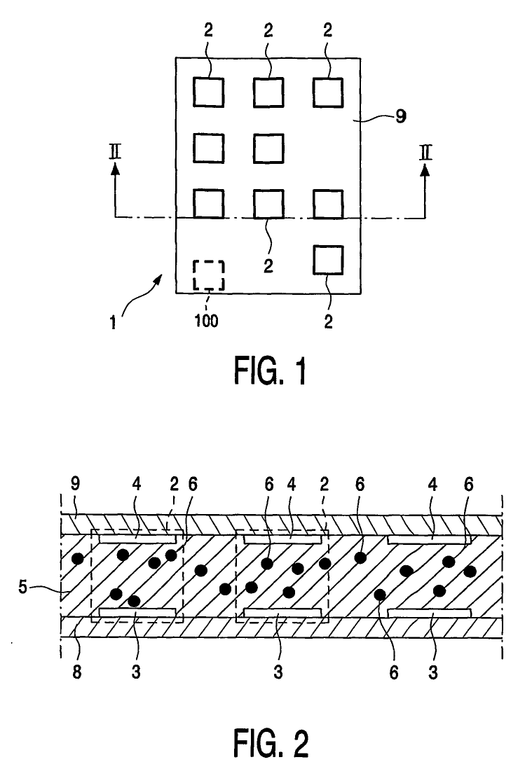

FIG. 1 shows diagrammatically a front view of an embodiment of the display panel;

FIG. 2 shows diagrammatically a cross-sectional view along II-II in FIG. 1;

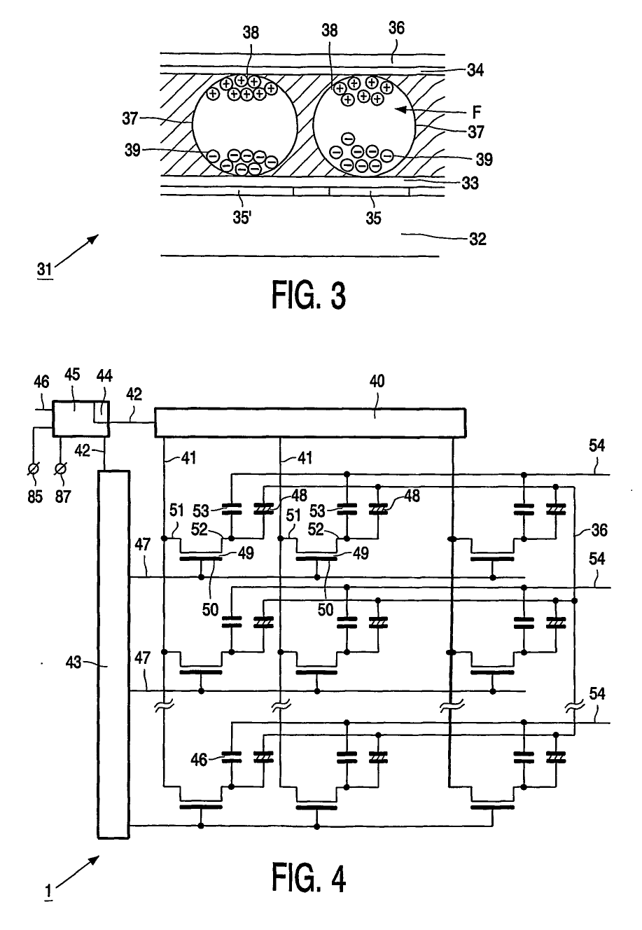

FIG. 3 shows diagrammatically a cross section of a portion of a further example of an electrophoretic display device;

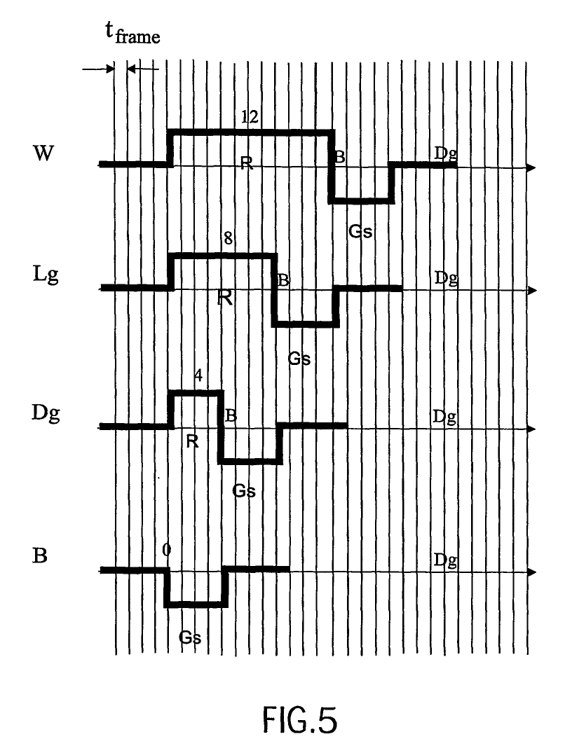

FIG. 4 shows diagrammatically an equivalent circuit of a picture display device of FIG. 3;

FIG. 5 illustrates by means of a driving scheme diagrammatically the potential difference as a function of time for a picture element;

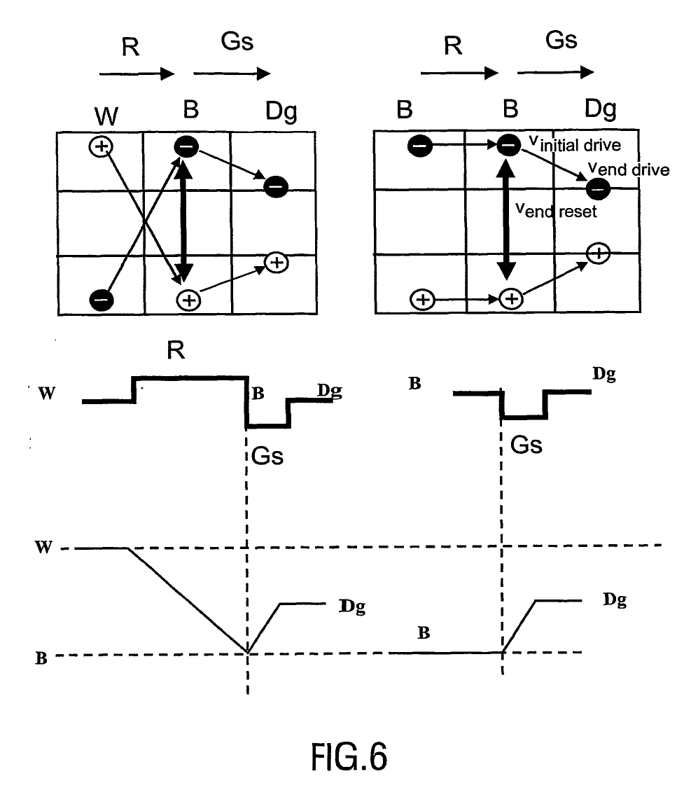

FIG. 6 illustrates the basic insight on which the invention is based;

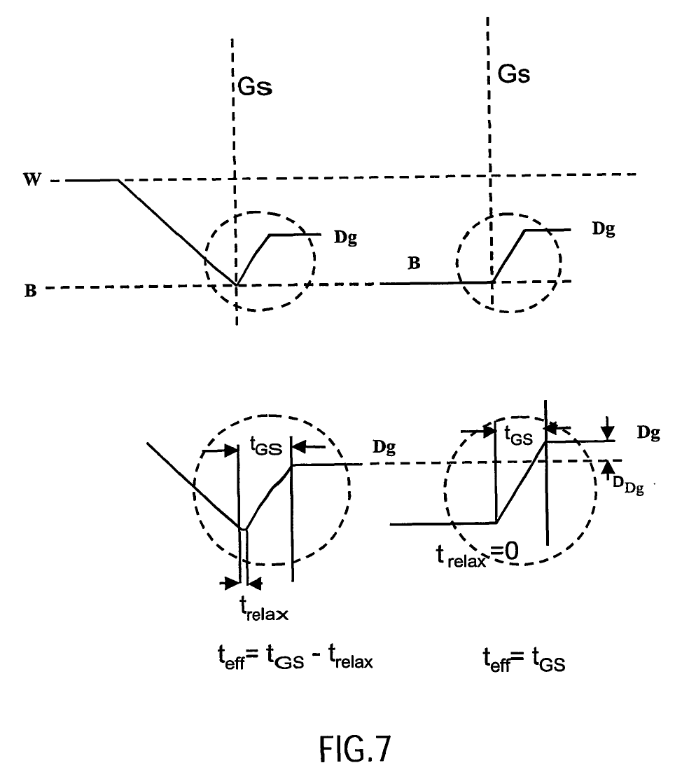

FIG. 7 illustrates the effect of relaxation of momentum of the particles in a device not in accordance with the invention.

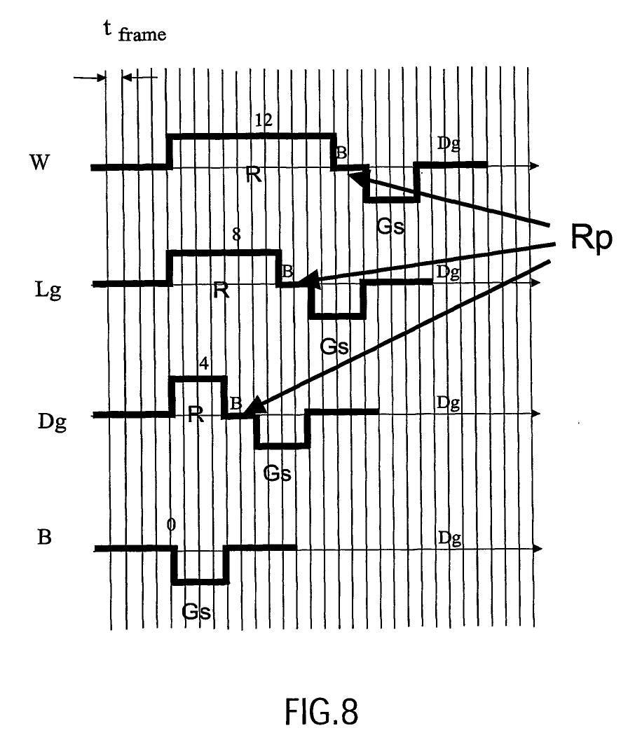

FIG. 8 shows by means of a driving scheme diagrammatically the potential difference as a function of time for a device in accordance with an embodiment of the invention;

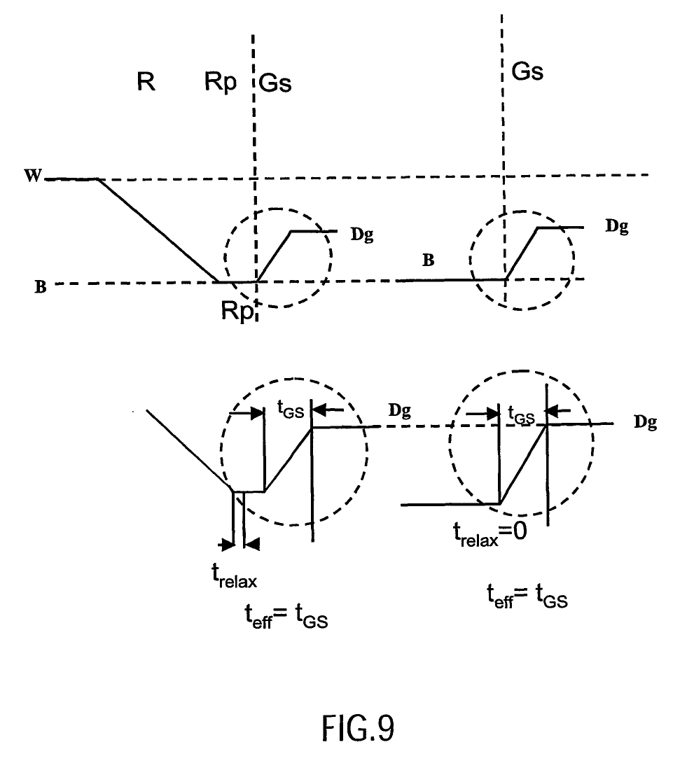

FIG. 9 illustrates the effect of relaxation of movement of particles for a device in accordance with the invention, and

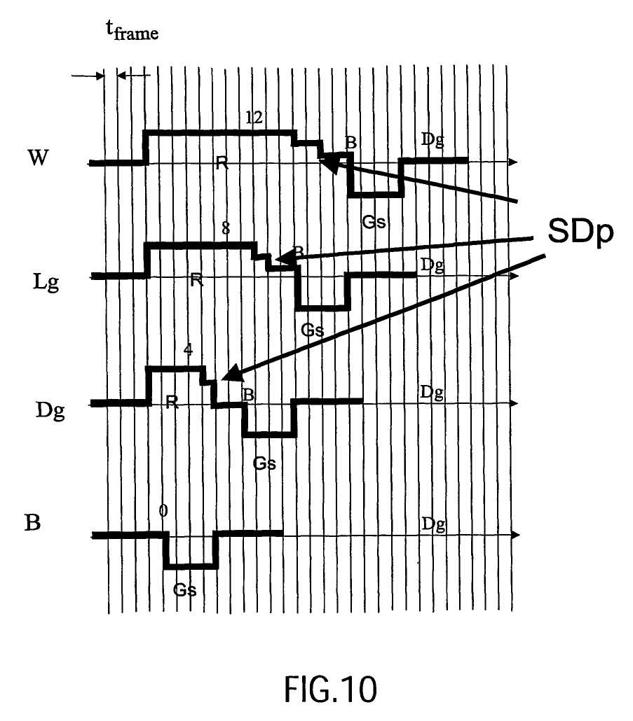

FIG. 10 shows by means of a driving scheme diagrammatically the potential difference as a function of time for a device in accordance with an embodiment of the invention;

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3,4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. Nos. 5,961,804, 6,120,839 and 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a grey scale potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power.

FIG. 4 shows diagrammatically an equivalent circuit of a picture display device 31 comprising an electrophoretic film laminated on a base substrate 32 provided with active switching elements, a row driver 43 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 43 consecutively selects the row electrodes 47, while a column driver 40 provides a data signal to the column electrode 41. Preferably, a processor 45 firstly processes incoming data 46 into the data signals. Mutual synchronization between the column driver 40 and the row driver 43 takes place via drive lines 42. Select signals from the row driver 43 select the pixel electrodes via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element. In this embodiment, the additional capacitor 53 is connected to one or more storage capacitor lines 54. Instead of TFT other switching elements can be applied such as diodes, MIM's, etc.

As an example (see FIG. 5) the appearance of a picture element of a subset is white (W), light gray (Lg), dark grey (Dg) or black (B), before application of the reset potential difference. Furthermore, the picture appearance corresponding to the image information of the same picture element is dark gray. For these example, the potential difference of the picture element is shown as a function of time in FIG. 5. The reset potential difference (R) has e.g. a value of 15 Volts during resetting, i.e. during reset period. The maximum reset duration in these example is for instance 12 frame times, e.g. if the frame time is 25 msec this corresponds to a total time of 300 msec. The reset time period is 0 frame periods (for resetting black to black), 4 frame periods (for resetting dark grey to black), 8 frame periods (for resetting light grey to black up to 12 frame periods (for resetting white to black). As a result, after application of the reset potential, each picture element has an appearance being substantially black, denoted as B. The grey scale potential difference (Gs) is applied after application of the reset pulse and is e.g. −15 Volts and a duration of in this example 4 frame times, which in this example is approximately 100 msec. As a result the picture element has, after application of the grey scale potential difference, an appearance being dark gray (G1), for displaying the picture. These examples are shown in FIG. 5, showing driving schemes without application of rest pulse or slow down pulse, i.e. outside the scope of the invention.

FIG. 6 illustrates the basic insight on which the present invention is based. The upper most part of the figure illustrates schematically the motion of a particle, the middle part gives the applied voltages, and the bottom part illustrates the whiteness of blackness. The underlying mechanism may be explained with the help of FIG. 6 upper part, in which the detailed motion of a white and a black particle is schematically shown for the two extreme transitions: white to dark grey (left hand picture) and black to dark grey (right-hand picture). For simplicity, only one particle is used for discussion and all the description for the white particle is also valid for the black particle. By applying a negative voltage on the top electrode, the positive charged white particle will move towards the bottom electrode requiring the maximum time (largest distance). Ideally, which ideal situation is schematically illustrated in FIG. 6, lower part, the intensity levels are the same. However, as the inventors have realized, in reality, after switching off the reset pulse R, the white (and/or black) particle will move further towards the bottom or top electrode because the motion speed gradually reaches zero. When the greyscale driving pulse GS is immediately supplied after the completion of the reset pulse, there is no time available for the relaxation of the particle because it must move in opposite direction. The speed of the particle motion at the end of the reset pulse (V_{end reset}) is apparently dependant on the image history, thus the initial speed and the end speed during driving. The greyscale error will be generated which is mainly determined by the position of the particles.

FIG. 7 illustrates this in more detail, wherein the grey scale values around the transition reset pulse-gray scale difference is shown in more detail.

After applying the reset pulse, the particles continue moving during a relaxation time tᵣₑₗₐₓ. In other words, it takes some times for the grey scale potential difference to stop this latent motion. Application of the gray scale difference potential immediately after the reset pulse results in an effective application time t_{eff} less than the actual time period t_{GS} in formula t_{eff}≈t_{GS}−tᵣₑₗₐₓ. The relaxation time period is zero, when no reset pulse is applied, as for instance is the case when the original image was black. As a result, even when applying exactly the same reset pulses and grey scale potential differences, there exists a difference in grey scale Δ_{Dg}, in other words a difference in grey scales. Therefore, for instance, when an image of a chess board (black and white areas) is changed into a dark grey area, the chess board leaves an after-image, i.e. it is still visible as a “ghost-image”.

FIG. 8 illustrates an embodiment of the invention. In between at least reset pulses of more than 50% of the maximum energy, in this case all reset pulses, a rest pulse (Rp) is applied. The length of the rest pulse is as long or longer than the relaxation time, i.e. tᵣₚ≧tᵣₑₗₐₓ. The relaxation time is dependent on the characteristics of the particles and the materials. The application time of the rest pulse is at least 2 msec, preferably a frame time and preferably longer than the relax time tᵣₑₗₐₓ. The momentum of the particles after application of the reset pulse may be dependent on the applied reset pulse (the longer the reset pulse the higher the momentum). Therefore in preferred embodiments the length of the rest pulse is a function of the reset pulse strength.

FIG. 9 illustrates the relation between relax time, application time of the rest pulse Rp, and the application period of the grey scale potential difference Gs. Because of the rest pulse the effective time of the grey scale potential difference is the same for a transition from white via black to dark grey as for black to dark grey.

FIG. 10 illustrates an embodiment of the invention in which between the reset pulse R and the grey scale potential difference Gs a slow down pulse with an intensity substantially smaller than the reset value is applied. The result is that the spread in momentum for the particles at the start of the application of the grey scale potential difference is, in comparison to the situation as schematically indicated in FIG. 5 reduced. A reduction in the spread of momentum results in a reduction in the spread of the achieved grey scale, i.e. a more uniform image.

It is remarked that, within the concept of the invention the application of reset potential difference may encompass, and in preferred embodiments does encompass, the application of overresetting. “Overresetting” stands for methods of application of reset potentials in which purposively, at least for the transition of some grey scale state (intermediate states) reset pulses are applied which have a longer time*voltage difference than needed to drive the relevant element to the desired extreme optical state. Such overresetting may be usefull to ensure that an extreme optical state is reached, or it may be used to simplify the application scheme, such that e.g. the same length of resetting pulse is used for the resetting of different grey scale to an extreme optical state.

In short the invention can be described by:

An electrophoretic display panel (1), comprises drive means (100) for controlling the potential difference of each picture element (2)
to be a reset potential difference for enabling particles (6) to substantially occupy one of the extreme positions, and subsequently
to be a grey scale potential difference for enabling the particles (6) to occupy the position corresponding to the image information.
   The drive means are arranged for applying, at least for reset potential differences representing 50% or more of the maximum reset pulse energy, one or more pulses (Rp, SDp) having a voltage value of substantially less than the reset value in between a reset potential difference and a grey scale potential difference.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

It will be obvious that many variations are possible within the scope of the invention without departing from the scope of the appended claims.

1. An electrophoretic display panel (1), comprising:
an electrophoretic medium (5) comprising charged particles (6);
a plurality of picture elements (2);
electrodes (3,4) associated with each picture element (2) for receiving a potential difference; and
drive means (100),
the drive means (100) being arranged for controlling the potential difference of each picture element (2)
to be a reset potential difference having a reset value and a reset duration for enabling particles (6) to substantially occupy one of the extreme positions, and subsequently
to be a grey scale potential difference for enabling the particles (6) to occupy the position corresponding to the image information,
wherein the drive means are further arranged for applying, at least for reset potential differences representing 50% or more of the maximum reset pulse energy, one or more pulses (Rp, SDp) having a voltage value of substantially less than the reset value in a time period in between application of a reset potential difference and a grey scale potential difference of opposite sign.

2. An electrophoretic display panel as claimed in claim 1, wherein the drive means are arranged for arranged for applying for all reset potential differences one or more pulses having a voltage value of substantially less than the reset value in a time period in between application of a reset potential difference and a grey scale potential difference of opposite sign.

3. An electrophoretic display panel as claimed in claim 1, wherein the time period is at least one frame time.

4. An electrophoretic display panel as claimed in claim 1, characterized in that the device comprises means for applying in between the reset pulse and the grey scale potential difference one or more pulses with steadily reducing voltage value.

5. An electrophoretic display panel as claimed in claim 1, wherein the device comprises means for applying in between the reset potential difference and the grey scale potential difference a rest pulse of zero voltage value.

6. An electrophoretic display panel as claimed in claim 4, wherein the device comprises means for applying in between the reset potential difference and the grey scale potential difference a rest pulse of zero voltage value for a period of at least 2 msec.

7. A method for driving an electrophoretic display device comprising:
an electrophoretic medium (5) comprising charged particles (6);
a plurality of picture elements (2), in which method reset potential differences are applied to elements of the display device, prior to application of grey scale potential differences,
wherein at least for reset potential differences representing 50% or more of the maximum reset pulse energy, one or more pulses (Rp, SDp) having a voltage value of substantially less than the reset value are applied in a time period in between application of the reset potential difference and a grey scale potential difference of opposite sign.

8. A method as claimed in claim 7, wherein for all reset potential differences one or more pulses (Rp, SDp) having a voltage value of substantially less than the reset value are applied in a time period in between application of the reset potential difference and a grey scale potential difference of opposite sign

9. A method as claimed in claim 7, wherein one or more pulses (SDp) with steadily reducing voltage value are applied.

10. A method as claimed in claim 7, wherein a rest pulse of zero voltage value is applied.

11. A method as claimed in claim 10, wherein the rest pulse of zero voltage is applied for a period of at least 2 msec.
